(19) United States
(12) Patent Application Publication
(10) Pub. No.: US 2020/0322529 A1
(43) Pub. Date: Oct. 8, 2020

(54) MONITORING SYSTEM

(71) Applicant: KYOCERA Document Solutions Inc., Osaka (JP)

(72) Inventors: Kosuke TAKI, Osaka-shi (JP); Yoichi HIRANUMA, Osaka-shi (JP); Fumiya SAKASHITA, Osaka-shi (JP); Shoichi SAKAGUCHI, Osaka-shi (JP); Shohei FUJIWARA, Osaka-shi (JP)

(73) Assignee: KYOCERA Document Solutions Inc., Osaka (JP)

(21) Appl. No.: 16/652,663

(22) PCT Filed: Jan. 23, 2019
(86) PCT No.: PCT/JP2019/002060

§ 371 Date: Mar. 31, 2020

(30) Foreign Application Priority Data
Mar. 29, 2018 (JP) 2018-063963

(51) Int. Cl. H04N 5/232; G06K 9/20; H04N 7/18

(52) U.S. Cl. CPC H04N 5/23229; H04N 7/183; G06K 9/2054

(57) ABSTRACT

A monitoring system includes an imaging sensor, an allocation section, and a setting section. The imaging element captures an image in a capture area to capture image data, thereby generating the captured image data. The captured image data represents the captured image. The allocation section allocates selection range candidates to the captured image. The setting section sets at least part of the selection range candidates as a selection range. The at least part includes one or more selection range candidates. According to a time interval, the setting section performs switching of the at least part of the selection range candidates that is set as the selection range.

### TECHNICAL FIELD

The present invention relates to a monitoring system.

### BACKGROUND ART

In recent years, many monitoring systems have been installed for the purpose of for example crime deterrent and accident prevention. A monitoring system is particularly installed in a facility that allows an unspecified number of people to enter and exit. Examples of the facility include a hotel, a building, a convenience store, a financial institution, a highway, and a railway. Such a monitoring system includes a camera that captures image data by taking a picture of persons, vehicles, and the like to be monitored. The captured image data is transmitted to a monitoring center such as a management office or a security room, and is stored as needed or according to purpose.

Here, privacy issues may be raised as a result of a standard home window or an area related to personal information being included in an image captured by the monitoring system. There is a known camera system in view of the issues that sets a mask area in a display image when an image taken by a camera is displayed on a display device (Patent Document 1).

### CITATION LIST

### Patent Literature

[Patent Document 1]

JP 2011-234237 A

### SUMMARY OF INVENTION

### Technical Problem

In the camera system of Patent Document 1, it is possible to set a specific area in an image taken by the camera as a mask area. The camera system of Patent Documents 1 however requires resetting the mask area each time the mask area needs to be changed, which makes it difficult to appropriately change the mask range according to a situation.

The present invention has been achieved in view of the above circumstances and an object thereof is to provide a monitoring system capable of changing a selection range within a captured image as appropriate according to a situation.

### Solution to Problem

A monitoring system according to an aspect of the present invention includes an imaging sensor, an allocation section, and a setting section. The imaging sensor captures an image in a capture area to generate captured image data representing a captured image. The allocation section allocates selection range candidates to the captured image. The setting section sets at least part of the selection range candidates as a selection range. Here, the at least part includes one or more selection range candidates. According to a time interval, the setting section performs switching of the at least part of the selection range candidates that is set as the selection range.

### Advantageous Effects of Invention

The present invention enables changing of the selection range within the captured image as appropriate according to a situation.

### BRIEF DESCRIPTION OF DRAWINGS

FIG. 1 is a block diagram of a monitoring system according to an embodiment of the present invention.

FIG. 2 is a schematic illustration of a captured image in the monitoring system according to the present embodiment.

FIG. 3 is a schematic illustration of the captured image to which selection range candidates are allocated, in the monitoring system according to the present embodiment.

FIG. 4 is a schematic illustration of a captured image to which a selection range is set, in the monitoring system according to the present embodiment.

FIG. 5A is a schematic illustration of a captured image, in which a selection range is set, during a time interval, in the monitoring system according to the present embodiment.

FIG. 5B is a schematic illustration of a captured image, in which a selection range is set, during a different time interval, in the monitoring system according to the present embodiment.

FIG. 6A is a schematic illustration of a captured image to which selection ranges are set, in the monitoring system according to the present embodiment.

FIG. 6B is a schematic illustration of a captured image to which selection ranges are set, in the monitoring system according to the present embodiment.

FIG. 6C is a schematic illustration of a captured image to which selection ranges are set, in the monitoring system according to the present embodiment.

FIG. 7 is a schematic illustration of a captured image to which selection ranges are set, in the monitoring system according to the present embodiment.

FIG. 8A is a schematic illustration of a captured image, in which selection ranges are set, during a time interval, in the monitoring system according to the present embodiment.

FIG. 8B is a schematic illustration of a captured image, in which selection ranges are set, during a next corresponding time interval, in the monitoring system according to the present embodiment.

FIG. 9 is a flowchart of setting of a selection range in the monitoring system according to the present embodiment.

FIG. 10 is a flowchart depicting switching of the selection range in the monitoring system according to the present embodiment.

FIG. 11A is a schematic illustration of a captured image, in which a selection range is set, during a time interval, in the monitoring system according to the present embodiment.

FIG. 11B is a schematic illustration of a captured image, in which a selection range is set, during a different time interval, in the monitoring system according to the present embodiment.

FIG. 12 is a block diagram of a monitoring system according to an embodiment of the present invention.

### DESCRIPTION OF EMBODIMENTS

A monitoring system according to an embodiment of the present invention will hereinafter be described with reference to the accompanying drawings. In the drawings, the same or equivalent elements are allocated the same reference signs, and description thereof will not be repeated.

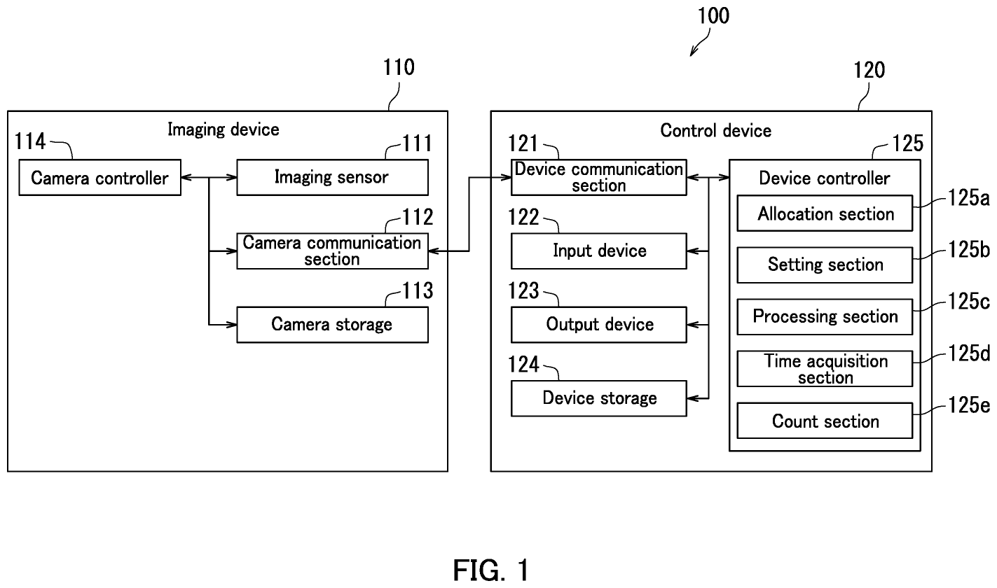

A monitoring system 100 according to the present embodiment will be described with reference to FIG. 1. FIG. 1 is a block diagram of the monitoring system 100.

The monitoring system 100 includes an imaging device 110 and a control device 120. The imaging device 110 captures an image in a capture area to generate captured image data representing the captured image. The captured image captured by the imaging device 110 may be a moving image or a still image. The control device 120 controls the imaging device 110. The control device 120 is located apart from the imaging device 110. The control device 120 is for example a server.

The imaging device 110 includes an imaging sensor 111, a camera communication section 112, camera storage 113, and a camera controller 114. The camera controller 114 controls the imaging sensor 111 and the camera communication section 112.

An imaging sensor 111 captures an image in the capture area. The imaging sensor 111 generates the captured image data representing the captured image and transmits the captured image data to the camera controller 114. Examples of the imaging sensor 111 include a charge coupled device (CCD) image sensor and a complementary metal oxide semiconductor (CMOS) image sensor.

The camera communication section 112 communicates with electronic devices each of which is equipped with a communication device using a communication method (protocol). Here, the protocol is the same as that of the camera communication section 112. The camera communication section 112 communicates with the control device 120 via a network such as a local area network (LAN). The camera communication section 112 is for example a communication module (communication device) such as a LAN board. In the present embodiment, the camera communication section 112 transmits the captured image data to the control device 120.

The camera storage 113 stores therein various data. The camera storage 113 includes semiconductor memory. Examples of the semiconductor memory include random-access memory (RAM) and read-only memory (ROM).

The camera storage 113 stores therein a camera control program. In addition, the camera storage 113 temporarily stores therein the captured image data generated by the imaging sensor 111. Further, the camera storage 113 deletes the captured image data stored in the camera storage 113 as needed.

The camera controller 114 executes the camera control program stored in the camera storage 113, thereby controlling respective operations of components of the imaging device 110. The camera controller 114 includes a processor. The processor may include a central processing unit (CPU). Alternatively, the processor may include a microcomputer. Alternatively, the processor may include an application specific integrated circuit.

The camera controller 114 detects a change of an image in a detection range within the captured image based on the captured image data. Data on the image in the detection range is stored in the camera storage 113. The camera controller 114 detects the change of the image in the detection range within the captured image based on for example a background subtraction method. Alternatively, the camera controller 114 detects the change of the image in the detection range within the captured image based on an inter-frame difference method. The detection range is set by for example an administrator of the monitoring system 100 in advance. When detecting the change of the image in the detection range within the captured image, the camera controller 114 transmits change detection data to the control device 120. The change detection data represents the captured image data in which the change of the image in the detection range within the captured image has been detected.

The control device 120 includes a device communication section 121, an input device 122, an output device 123, device storage 124, and a device controller 125. The device controller 125 controls the device communication section 121, the input device 122, and the output device 123.

The device communication section 121 is configured to communicate with electronic devices each of which is equipped with a communication device using a communication method (protocol). Here, the protocol of the communication devices of the electronic devices is the same as that of the device communication section 121. The device communication section 121 communicates with the camera communication section 112 via a network such as a LAN. The device communication section 121 is for example a communication module (communication device) such as a LAN board. In the present embodiment, the device communication section 121 receives the captured image data from the camera communication section 112. In addition, when the camera controller 114 detects a change of the captured image, the device communication section 121 receives corresponding change detection data from the camera communication section 112.

The input device 122 allows an operator to enter an input instruction into the control device 120. In the present embodiment, the input device 122 includes a keyboard and a mouse. Alternatively, the input device 122 may include a touch sensor.

The output device 123 outputs the captured image based on the captured image data received through the device communication section 121. In the present embodiment, the output device 123 includes a display. For example, the display includes a liquid-crystal display.

The device storage 124 stores therein various data. The device storage 124 includes a storage device and semiconductor memory. Examples of the storage device include a hard disk drive (HDD) and a solid state drive (SSD). Examples of the semiconductor memory include RAM and ROM.

The device storage 124 stores therein a device control program. The device storage 124 also stores therein the captured image data received through the device communication section 121 and the camera communication section 112. The device storage 124 further stores therein the change detection data received through the device communication section 121 and the camera communication section 112.

The device storage 124 may further store therein target image data. The target image data represents a target image that is an image of a detection target (target to be detected) and that is set by the administrator in advance.

The device storage 124 may store therein reference background data. The reference background data represents a reference background image that is a reference provided for an image to be captured. For example, the reference background image represents a background image before presence of the detection target in the capture area captured by the imaging sensor 111. Alternatively, the reference background image represents a background image with the detection target placed in the capture area captured by the imaging sensor 111.

The device storage 124 further stores therein time intervals that are set in advance. Examples of the time intervals stored in the device storage 124 include a first time interval from 9:00 a.m. to 12:00 a.m. and a second time interval from 1:00 p.m. to 6:00 p.m.

The device controller 125 executes the device control program stored in the device storage 124, thereby controlling respective operations of components of the control device 120. The device controller 125 includes a processor. The processor may include a central processing unit (CPU). Alternatively, the processor may include a microcomputer. Alternatively, the processor may include an application specific integrated circuit.

The device controller 125 allows the administrator to set the detection range therein. The device controller 125 causes for example the output device 123 to display an on-screen setting. Here, the on-screen setting allows the administrator to set the detection range in the captured image on the output device 123. This enables the administrator to set the detection range by operating the input device 122 when the on-screen setting is displayed. Data on an image in the detection range is to be transmitted to the camera communication section 112 through the device communication section 121. When the camera communication section 112 receives the data on the image in the detection range, the camera controller 114 stores the data on the image in the detection range in the camera storage 113. The camera controller 114 detects a change of the captured image based on the data on the image in the detection range stored in the camera storage 113.

When the input device 122 receives an output instruction of the captured image, the device controller 125 causes the output device 123 to output the captured image based on the captured image data received through the device communication section 121. Alternatively, the device controller 125 causes the output device 123 to output the captured image based on the captured image data stored in the device storage 124.

The device controller 125 in the monitoring system 100 according to the present embodiment includes an allocation section 125a and a setting section 125b. The allocation section 125a allocates selection range candidates to the captured image. For example, the allocation section 125a allocates the selection range candidates to the captured image stored in the device storage 124. Alternatively, the allocation section 125a allocates the selection range candidates to the captured image stored in the camera storage 113.

The setting section 125b sets at least part of the selection range candidates as a selection range. Here, the part includes one or more selection range candidates. The setting section 125b may set some neighboring selection range candidates as one selection range. Alternatively, the setting section 125b may set groups placed apart from each other as different selection ranges. Here, each of the groups includes one or more selection range candidate.

For example, the setting section 125b sets part of the selection range candidates as the detection range. Here, the part includes one or more selection range candidates. The selection range set by the setting section 125b may be transmitted to the imaging device 110 through the device communication section 121 and set as a range to be detected by the imaging device 110. Alternatively, the detection range set by the setting section 125b may be set as a range to be detected by the control device 120 in addition to the range to be detected by the imaging device 110.

Alternatively, the setting section 125b may set part of the selection range candidates as a mask range. Here, the part includes one or more selection range candidates. The mask range set by the setting section 125b serves as a range for mask processing of the captured image data transmitted to the control device 120 from the imaging device 110.

The setting section 125b in the monitoring system 100 according to the present embodiment performs, according to a time interval, switching of the part of the selection range candidates that is set as the selection range. It is accordingly possible to appropriately change the selection range according to a situation.

The device controller 125 preferably further includes a processing section 125c. The processing section 125c performs processing of an image in the selection range within the captured image based on the captured image data. For example, the processing section 125c detects the image in the selection range within the captured image based on the captured image data. In this case, the processing section 125c is to detect an image in only the part of the selection range candidates that is set as the selection range. Here, the part includes one or more selection range candidates. It is therefore possible to reduce a data processing amount to be required as compared to a data processing amount when detecting the entire captured image.

The processing section 125c detects a change of the image in the selection range, as the detection range, within the captured image stored in the device storage 124. In this case, data on the image in the detection range is stored in the device storage 124. The processing section 125c detects the change of the image in the detection range within the captured image based on for example a background subtraction method. Alternatively, the processing section 125c detects the change of the image in the detection range within the captured image based on an inter-frame difference method. When the processing section 125c detects the change of the image in the detection range within the captured image, the device controller 125 causes the device storage 124 to keep storing the captured image.

Note that the processing section 125c may detect, of the change of the image in the detection range within the captured image, a change of the detection target. For example, the processing section 125c detects a movement of the detection target within the captured image. In this case, when the processing section 125c detects the change of the detection target within the captured image, the device controller 125 causes the device storage 124 to keep storing the captured image.

Alternatively, the processing section 125c may detect, of the change of the image in the detection range within the captured image, a change of a reference background. For example, the processing section 125c detects that capturing of the reference background has been disturbed based on the fact that part of the reference background is not included in the captured image for a predetermined period. The processing section 125c detects that capturing of the reference background included in the detection range within the captured image is disturbed sequentially from left to right, thereby enabling detection of an obstacle passing from left to right while disturbing the reference background. When the processing section 125c detects that the capturing of the reference background within the captured image has been disturbed, the device controller 125 causes the device storage 124 to keep storing the captured image.

Alternatively, the processing section 125c may mask the selection range within the captured image based on the captured image data. The processing section 125c selects only specific part of the selection range candidates within the captured image to mask the part. It is therefore possible to avoid a privacy problem even if the captured image is output by the output device 123.

Preferably, the device controller 125 further includes a time acquisition section 125d. The time acquisition section 125d acquires the time. The time acquisition section 125d may measure the time by itself. For example, the time acquisition section 125d may include a real time clock. Alternatively, the time acquisition section 125d need not necessarily measure the time by itself. For example, the time acquisition section 125d may receive the time from an external device through the device communication section 121. According to the time acquired through the time acquisition section 125d, the setting section 125b performs switching of the part of the selection range candidates that is set as the selection range.

Preferably, the device controller 125 further includes a count section 125e. The count section 125e counts the number of times a change of an image in the detection range within the captured image is detected. For example, the count section 125e may be configured so that every time the processing section 125c detects a change of an image in the detection range within the captured image according to the background subtraction method or the inter-frame difference method, the count section 125e counts the number of times the processing section 125c detects the change.

Alternatively, the count section 125e may count the number of times the occurrence of a specific event is detected from an image in the detection range within the captured image. In one example, several hundred pieces of printed matter previously arranged in the capture area are set as the detection target. In this case, the processing section 125c detecting a person who has carried away some pieces of the printed matter or some pieces of the printed matter that have been carried away enables the count section 125e to count the number of people who took away the printed matter or the number of pieces of printed matter removed.

Setting of a selection range SR to a captured image M in the monitoring system 100 according to the present embodiment will hereinafter described with reference to FIGS. 1 to 4. Here, the selection range SR corresponds to part (one or more selection range candidates CS) of the selection range candidates CS.

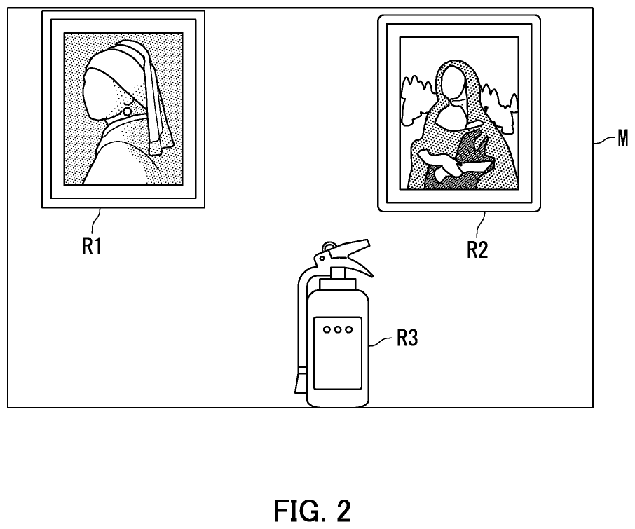

FIG. 2 is a schematic illustration of a captured image M in the monitoring system 100 according to the present embodiment. The imaging sensor 111 captures an image to obtain a captured image M. The captured image M is displayed on for example the output device 123.

The captured image M includes an image region R1, an image region R2, and an image region R3. The image region R1 is a region that is located on the upper left in the captured image M and that includes an image of human painting in a frame. The image region R2 is a region that is located on the upper right in the captured image M and that includes an image of another human painting in a frame. The image region R3 is a region that is located below the center in the captured image M and that includes an image of a fire extinguisher.

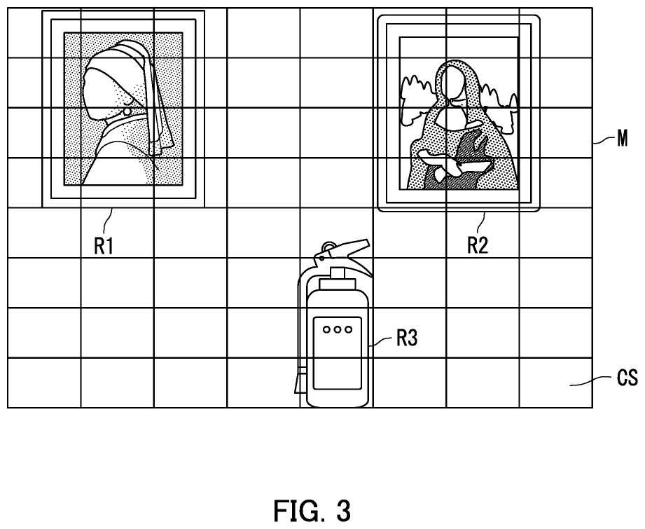

FIG. 3 is a schematic illustration of the captured image M to which the selection range candidates CS are allocated, in the monitoring system 100 according to the present embodiment. In FIG. 3, the selection range candidates CS are allocated to the captured image M. For example, the input device 122 illustrated in FIG. 1 allows the operator to enter the selection range candidates CS to be allocated to the captured image M into the allocation section 125a. The allocation section 125a allocates the selection range candidates CS to the captured image M. [0049]

For example, the allocation section 125a allocates the selection range candidates CS arranged in a matrix of rows and columns to the captured image M.

Here, the allocation section 125a allocates selection range candidates CS of 8 rows and 8 columns to the captured image M. Note that a dimension of the captured image M in a row direction is greater than a dimension of the captured image M in a column direction. Similarly, a dimension of each selection range candidate CS in the row direction is greater than a dimension of each selection range candidate CS in the column direction.

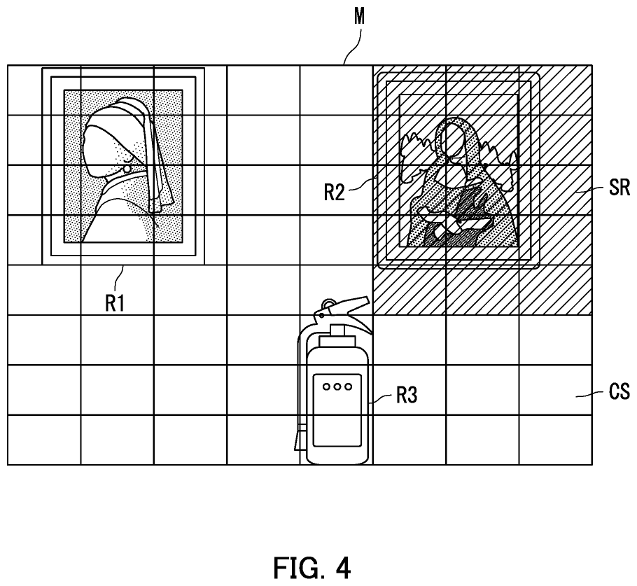

FIG. 4 is a schematic illustration of the captured image M in which a selection range SR is set, in the monitoring system 100 according to the present embodiment. Here, of the selection range candidates CS, selection range candidates CS of 5 rows and 3 columns on the upper right including the image region R2 are set as the selection range SR. The operator sets, of the selection range candidates CS, the selection range candidates CS of 5 rows and 3 columns on the upper right as the selection range SR through the input device 122 illustrated in FIG. 1. The setting section 125b sets, as the selection range SR, the selection range candidates CS of 5 rows and 3 columns on the upper right that are allocated to the captured image M. As described above, the selection range SR is set in the captured image M.

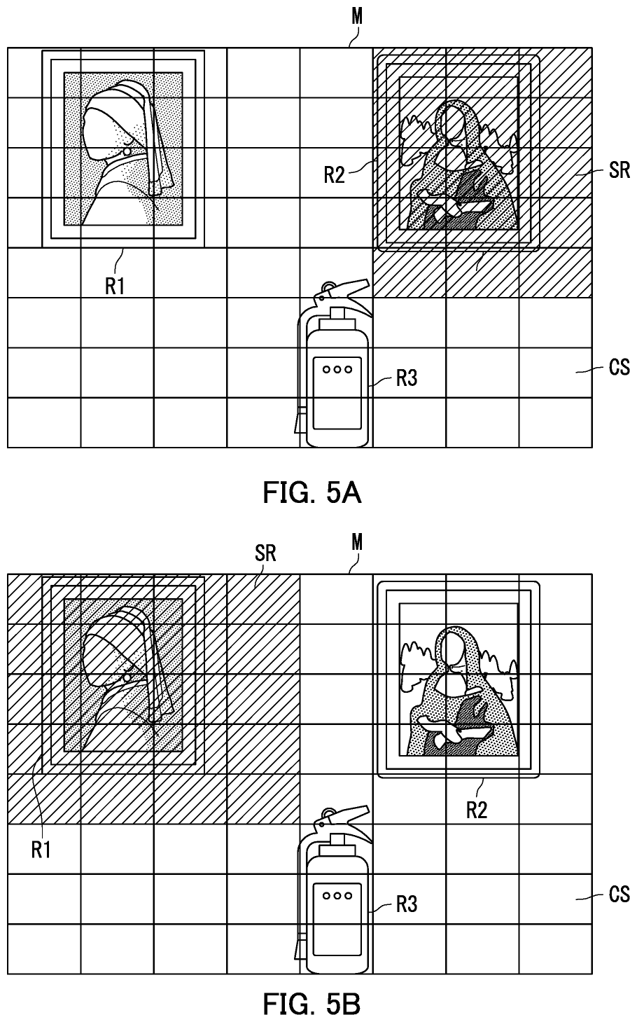

The selection range SR in the monitoring system 100 according to the present embodiment will hereinafter be described with reference to FIGS. 5A and 5B. FIG. 5A is a schematic illustration of the captured image M, in which a selection range SR is set, during a time interval, in the monitoring system 100. FIG. 5B is a schematic illustration of the captured image M, in which a different selection range SR is set, during a different time interval, in the monitoring system 100.

As illustrated in FIG. 5A, the selection range SR is set on the upper right in the captured image M during a time interval. For example, in the morning, an upper right part in the captured image M is set as the selection range SR. The operator performs an operation for setting, of the selection range candidates CS, the selection range candidates CS of 5 rows and 3 columns on the upper right as the selection range through the input device 122 illustrated in FIG. 1. The setting section 125b sets the selection range candidates CS on the upper right as the selection range SR.

As illustrated in FIG. 5B, the different selection range SR is set on the upper left in the captured image M during a different time interval. For example, in the afternoon, an upper left part in the captured image M is set as the different selection range SR. The operator performs an operation for setting, of the selection range candidates CS, selection range candidates CS of 5 rows and 4 columns on the upper left as the different selection range through the input device 122 illustrated in FIG. 1. In this case, the setting section 125b sets the selection range candidates CS on the upper left as the different selection range SR.

It is assumed for example that many people appreciate the painting on the upper right in the morning. In this case, preferably in the morning the selection range candidates CS on the upper right in the captured image M are set as the selection range SR and an image in the selection range SR is detected. It is also assumed for example that many people appreciate the painting on the upper left in the afternoon. In this case, preferably in the afternoon the selection range candidates CS on the upper left in the captured image M are set as the different selection range SR and an image in the different selection range SR is detected.

Alternatively, it is assumed that a request to prohibit monitoring is made from a group that would like to view the paining on the upper right in the morning. In this case, in the morning the selection range candidates CS on the upper right in the captured image M are set as the selection range SR in order to mask the selection range SR within the captured image M. It is also assumed that a request to prohibit monitoring is made from a group that would like to view the paining on the upper left in the afternoon. In this case, in the afternoon the selection range candidates on the upper left in the captured image M are set as the different selection range SR in order to mask the different selection range SR within the captured image M. As described above, appropriate switching between the selection ranges SR according to the respective time intervals enables appropriate changing of the selection range SR within the captured image M as appropriate according to a situation.

Note that when the processing section 125c detects a change of an image in the selection range SR, the count section 125e illustrated in FIG. 1 may count the number of times a change of an image in the selection range within the captured image is detected according to a time interval. The setting section 125b may reset the selection range SR based on the time interval and the counted number of times. For example, the count section 125e may count the number of times a change of an image in the detection range within the captured image is detected during a corresponding time interval, and the setting section 125b may reset the selection range SR based on the time interval and the counted number of times.

Note that although one selection range is set during one time interval as described above with reference to FIGS. 4, 5A, and 5B, the present invention is not limited to this. Selection ranges may be set during one time interval.

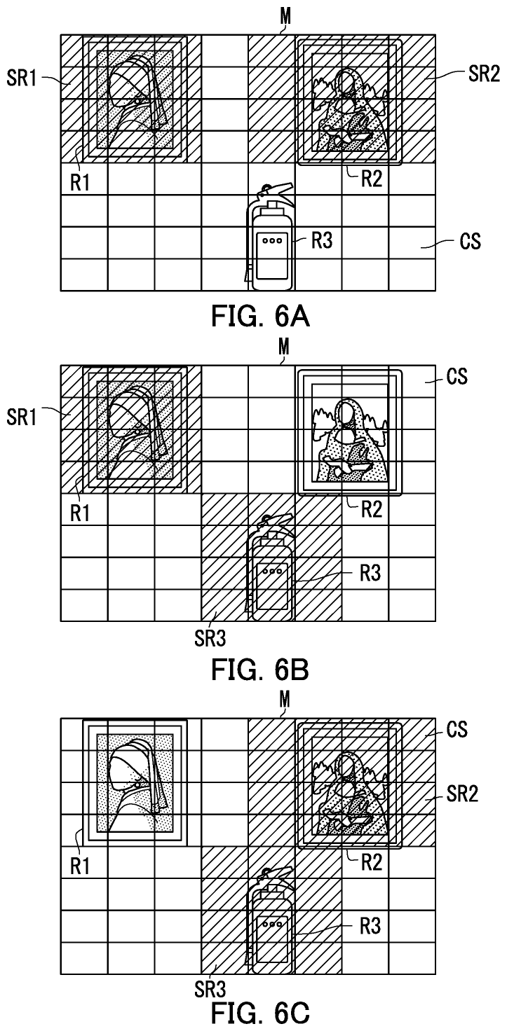

The monitoring system 100 according to the present embodiment will hereinafter be described with reference to FIGS. 1, 6A, 6B, and 6C. Each of FIGS. 6A to 6C is a schematic illustration of the captured image M in which selection ranges are set, in the monitoring system 100 according to the present embodiment. Herein, the processing section 125c detects a change of an image in each of the selection ranges within the captured image M. The count section 125e counts the number of times a change of an image in each of selection ranges during a first time interval, a second time interval, and a third time interval is detected.

FIG. 6A is a schematic illustration of the captured image M, in which selection ranges SR1 and SR2 are set, during the first time interval. During the first time interval, the selection ranges SR1 and SR2 are set in the captured image M. For example, the first time interval is a time interval of 9:00 a.m. to 12:00 a.m. on Thursday, February 15.

The selection range SR1 is located on the upper left in the captured image M, and 12 selection range candidates CS of 4 rows and 3 columns are set as the selection range SR1. The selection range SR2 is located on the upper right in the captured image M, and 16 selection range candidates CS of 4 rows and 4 columns are set as the selection range SR2. The setting section 125b sets the selection ranges SR1 and SR2 in the captured image M, and the processing section 125c detects a change of an image in each of the selection ranges SR1 and SR2 within the captured image M.

The count section 125e counts the number of times a change of an image in each of the selection ranges SR1 and SR2 is detected over the first time interval. For example, the counted number of times in the selection range SR1 is 30 times, and the counted number of times in the selection range SR2 is 15 times.

FIG. 6B is a schematic illustration of the captured image M, in which selection ranges SR1 and SR3 are set, during the second time interval. During the second time interval, the selection ranges SR1 and SR3 are set in the captured image M. For example, the second time interval is a time interval of 1:00 p.m. to 6:00 p.m. on the same day. Here, the selection range SR1 is the same as the selection range SR1 during the first time interval. In addition, the selection range SR3 is located below the center in the captured image M, and 12 selection range candidates CS of 4 rows and 3 columns are set as the selection range SR3. The setting section 125b sets the selection ranges SR1 and SR3 in the captured image M, and the processing section 125c detects a change of an image in each of the selection ranges SR1 and SR3 within the captured image M.

The count section 125e counts the number of times a change of an image in each of the selection ranges SR1 and SR3 is detected over the second time interval. For example, the counted number of times in the selection range SR1 is 20 times, and the counted number of times in the selection range SR3 is 50 times.

FIG. 6C is a schematic illustration of the captured image M, in which selection ranges SR2 and SR3 are set, during the third time interval. During the third time interval, the selection ranges SR2 and SR3 are set in the captured image M. For example, the third time interval is a time interval of 11:00 p.m. on the same day to 6 a.m. the next day. Here, the selection range SR2 is the same as the selection range SR2 during the first time interval, and the selection range SR3 is the same as the selection range SR3 during the second time interval. The setting section 125b sets the selection ranges SR2 and SR3 in the captured image M, and the processing section 125c detects a change of an image in each of the selection ranges SR2 and SR3 within the captured image M.

The count section 125e counts the number of times a change of an image in each of the selection ranges SR2 and SR3 within the captured image M is detected over the third time interval. For example, the counted number of times in the selection range SR2 is 20 times, and the counted number of times in the selection range SR3 is 60 times.

Note that the setting section 125b may change next and subsequent selection ranges SR based on a count result by the count section 125e. In this case, when setting next selection ranges SR, the setting section 125b resets each of the selection ranges SR so as to change, according to a time interval, part of the selection range candidates that is set as a corresponding selection range.

For example, it is assumed that the number of times a change of an image in part of the selection range candidates CS that is set as a selection range SR during a time interval is small. In this case, the setting section 125b may decrease the number of part of the selection range candidates CS that is set as the selection range SR during a next corresponding time interval. The counted number of times in the selection range SR2 during the first time interval is 15 times that is relatively small. Therefore, the number of the part of the selection range candidates that is set as the selection range SR2 during the first time interval may be decreased.

In one example, the setting section 125b has set, during the previous first time interval, 16 selection range candidates CS of 4 rows and 4 columns as the selection range SR2. During a next first time interval, the setting section 125b removes, from the previously set 16 selection range candidates CS of 4 rows and 4 columns, selection range candidates CS arranged in the first and fourth rows and the first and fourth columns on the periphery thereof. Thus, selection range candidates CS of 2 rows and 2 columns are reset as a selection range SR2.

Alternatively, it is assumed that the number of times a change of an image in part of the selection range candidates CS that is set as a selection range SR during a time interval is large. In this case, the setting section 125b may increase the number of part of the selection range candidates CS that is set as a selection range SR during a next corresponding time interval. For example, the counted number of times in the selection range SR3 during the third time interval is 60 times that is relatively large. Therefore, the number of part of the selection range candidates CS that is set as a selection range SR3 during a next third time interval may be increased.

In one example, the setting section 125b has set, during the previous third time interval, 12 selection range candidates CS of 4 rows and 3 columns as the selection range SR3. During a next third interval, the setting section 125b newly adds, to the selection range SR3, selection range candidates CS forming a new first row and new first and fifth column which are to be arranged on the periphery of the previously set 12 selection range candidates CS of 4 rows and 3 columns. Thus, selection range candidates CS of 5 rows and 5 columns are reset as the selection range SR3.

For example, the setting section 125b may reset, during next and subsequent time intervals, next and subsequent corresponding selection ranges in units of days, days of the week, or months. Here, the setting section 125b may change, on next and subsequent days (on and after February 16), next and subsequent corresponding selection ranges SR. Alternatively, the setting section 125b may change, on 15th day in next month (March 15) and corresponding days in subsequent months, next and subsequent corresponding selection ranges SR. The setting section 125b may change, on Thursdays on or after February 22, next and subsequent corresponding selection ranges SR.

Note that when, of two neighboring selection ranges during a time interval, part of the selection range candidates CS that is set as a selection range are expanded in a row or column direction, the selection range may overlap with a different selection range. In this case, the part of the selection range candidates that is set as the selection range may be expanded in a row or column direction with part of the selection range candidates that is set as the different selection range being canceled once.

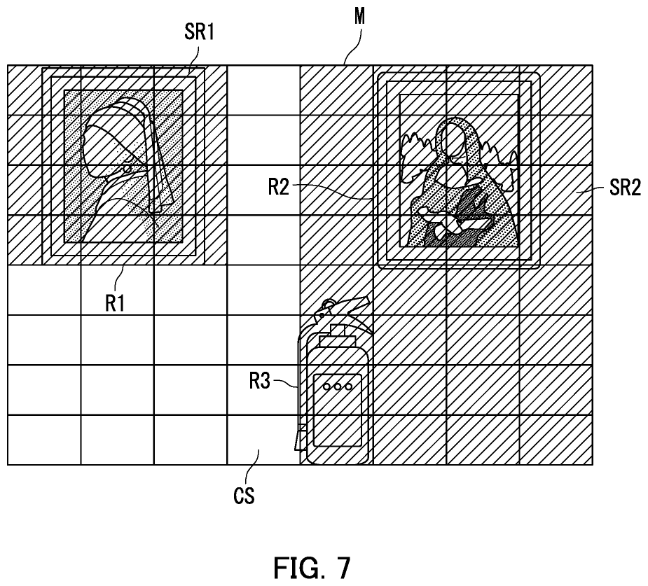

For example, when, of the selection ranges SR2 and SR3 during the third time interval illustrated in FIG. 6C, the selection range candidates CS of 4 rows and 4 columns that are set as the selection range SR2 are expanded in the column direction, some of the expanded selection range candidates overlap the selection range SR3. In this case, as illustrated in FIG. 7, the setting section 125b may cancel once the setting of the selection range candidates that are set as the selection range SR3 and expand the selection range candidates CS that are set as the selection range SR2 in the column direction, thereby resetting the expanded selection range candidates CS as a new selection range SR2.

Note that although the setting section 125b resets a selection range(s) SR during a next corresponding time interval based on the count result by the count section 125e as described above with reference to FIGS. 1, 6A, 6B, 6C, and 7, the present invention is not limited to this. The setting section 125b may change setting of a selection range(s) SR during a next corresponding time interval based on the count result by the count section 125e.

For example, it is assumed that the imaging sensor 111 is capturing a 10-person group traveling along a path defining a travel direction. In addition, it is assumed that the processing section 125c detects that the 10 persons have passed selection ranges SR1, SR2, and SR3 during a time interval. In this case, the setting section 125b may end the setting of the selection ranges SR1, SR2, and SR3 over the remaining time in the same time interval, thereby causing the processing section 125c to end detecting respective changes of images in the selection ranges SR1, SR2, and SR3.

Note that although any part of the selection range candidates is switchable between setting as a selection range and cancellation of the setting according to the counted number of times as described above with reference to FIGS. 1 to 7, the present invention is not limited to this. A specific selection range candidate in part of the selection range candidates may always be set as a selection range at least during a specific time interval without being canceled (removed) from the selection range regardless of the counted number of times.

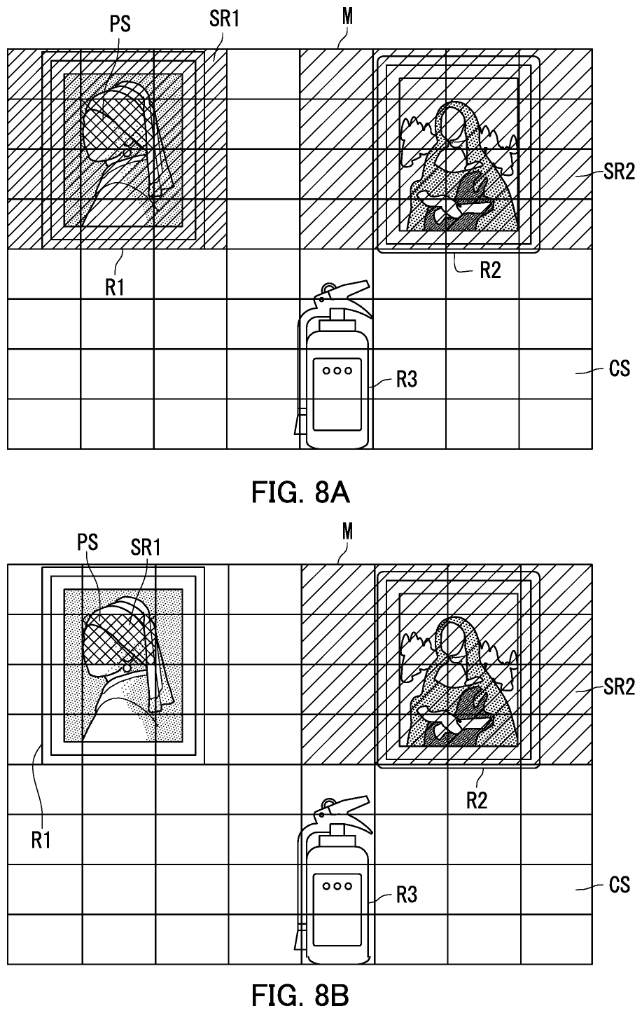

A cancellation prohibition candidate that is a specific selection range candidate prohibited from being canceled (removed) from the selection range will hereinafter be described with reference to FIGS. 8A and 8B. FIG. 8A is a schematic illustration of the captured image M, in which selection ranges are set, during a time interval, in the monitoring system according to the present embodiment. FIG. 8B is a schematic illustration of the captured image M, in which selection ranges are set, during a next corresponding time interval, in the monitoring system according to the present embodiment.

As illustrated in FIG. 8A, during a first time interval, selection ranges SR1 and SR2 are set in the captured image M. Here, the allocation section 125a allocates selection range candidates CS of 8 rows and 8 columns in the captured image M. Note that the allocation section 125a sets, of the selection range candidates CS of 8 rows and 8, a selection range candidate CS in a second row and a second column as a cancellation prohibition candidate PS. The cancellation prohibition candidate PS is a selection range candidate prohibited from being canceled (removed) from a corresponding selection range.

The count section 125e counts the number of times respective changes of images in the selection ranges SR1 and SR2 within the captured image M are detected over the first time interval. For example, the counted number of times in the selection range SR1 is 10 times, and the counted number of times in the selection range SR2 is 25 times. The counted number of times in the selection range SR1 is small, and the setting section 125b therefore cancels setting of a selection range SR1 during a next first time interval. The selection range candidate CS in the second row and the second column is however set as the cancellation prohibition candidate PS. This disables the whole setting of part of the selection range candidates CS that is set as the selection range SR1 from being canceled during a next first time interval.

As illustrated in FIG. 8B, during the next first time interval, selection ranges SR1 and SR2 are set in the captured image M. Here, the selection range SR2 is the same as the selection range SR2 during the previous first time interval. In contrast, except that the cancellation prohibition candidate PS is set as the selection range SR1, the other selection range candidates are canceled (removed) from a corresponding part of the selection range candidates. Thus, the allocation section 125a allocates the specific selection range candidate CS as the cancellation prohibition candidate PS to the selection range SR1, thereby causing the setting section 125b to set the cancellation prohibition candidate as the selection range SR1 at least during a specific time interval.

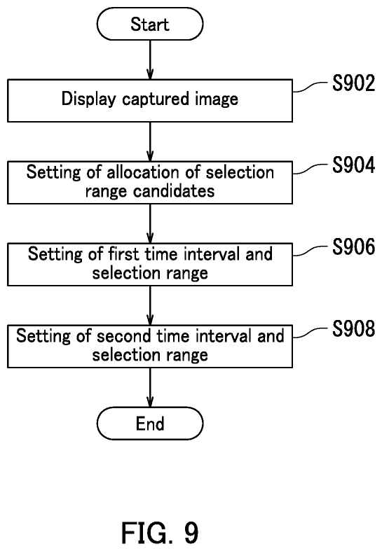

A setting process of a selection range in the monitoring system 100 according to the present embodiment will hereinafter be described with reference to FIGS. 1 and 9. FIG. 9 is a flowchart of the setting process of the selection range in the monitoring system according to the present embodiment.

As illustrated in FIG. 9, a captured image is first output (S902). For example, captured image data generated in the imaging sensor 111 of the imaging device 110 is transmitted to the device communication section 121 of the control device 120 through the camera communication section 112 and stored in the device storage 124. The output device 123 of the control device 120 outputs the captured image based on the captured image data.

Setting for allocating selection range candidates to the captured image is then performed (S904). An operator enters information on the allocation of the selection range candidates through the input device 122. For example, the number of rows and the number of columns for dividing the captured images into the selection range candidates are entered through the input device 122. As one example, as a result of 8 rows and 8 columns into which the captured image is divided being entered through the input device 122, the allocation section 125a allocates 64 selection range candidates of 8 rows and 8 columns to the captured image M as illustrated in FIG. 3. The device storage 124 stores therein the allocation of the selection range candidates.

A first time interval and a selection range are then set (S906). The operator enters start time and end time of the first time interval thought the input device 122. As one example, the start time and the end time of the first time interval that are entered through the input device 122 are 10 a.m. and 12 a.m., respectively. The device storage 124 stores therein the start time and the end time of the first time interval. Thus, a time interval from 10 a.m. to 12 a.m. is set as the first time interval.

The operator also enters a selection range during the first time interval thought the input device 122. For example, it is assumed that the input device 122 includes a touch sensor attached to a display included in the output device 123. In this case, the operator touches specific part of the selection range candidates on the touch sensor. The device storage 124 accordingly stores therein the selection range during the first time interval. Alternatively, it is assumed that the input device 122 includes at least one of devices whose examples include a keyboard and a mouse. In this case, the operator specifies part of the selection range candidates through the at least one of the devices. The device storage 124 stores therein the selection range during the first time interval. This enables the setting of the first time interval and the selection range.

Similarly, a second time interval and a selection range are set (S908). The operator enters start time and end time of the second time interval through the input device 122. As one example, the start time and the end time of the second time interval that are entered through the input device 122 are 1 p.m. and 3 p.m., respectively. The device storage 124 stores therein the start time and the end time of the second time interval. Thus, a time interval from 1 p.m. to 3 p.m. is set as the second time interval.

The operator also enters a selection range during the second time interval through the input device 122. For example, it is assumed that the input device 122 includes the touch sensor attached to the display included in the output device 123. In this case, the operator touches specific part of the selection range candidates on the touch sensor. The device storage 124 accordingly stores therein the selection range during the second time interval. Alternatively, it is assumed that the input device 122 includes at least one of the devices whose examples include a keyboard and a mouse. In this case, the operator specifies part of the selection range candidates through the at least one of the devices. The device storage 124 stores therein the selection range during the second time interval. This enables the setting of the second time interval and the selection range. As described above, the monitoring system 100 allows the setting of a selection range during a time interval.

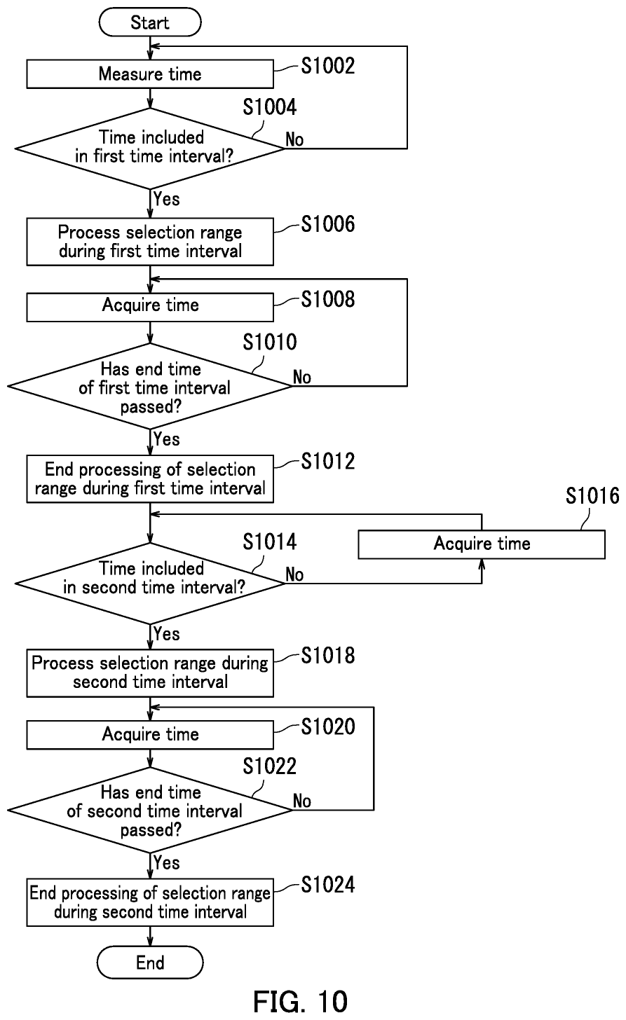

A process of switching between selection ranges in the monitoring system 100 according to the present embodiment will next be described with reference to FIGS. 1 and 10. FIG. 10 is a flowchart of the process of switching between the selection ranges in the monitoring system 100 according to the present embodiment.

The time acquisition section 125d first acquires the time (S1002). The time acquisition section 125d may measure the time by itself. Alternatively, the time acquisition section 125d may acquire the time transmitted from an external device.

The processing section 125c then determines whether or not the time is included in the first time interval (S1004). When it is determined that the time is not included in the first time interval (No at S1004), the time acquisition section 125d acquires the time again (S1002).

When it is determined that the time is included in the first time interval (Yes at S1004), the processing section 125c starts processing of an image in the selection range within the captured image, during the first time interval (S1006). The time acquisition section 125d subsequently acquires the time (S1008). The processing section 125c then determines based on the time whether or not the end time of the first time interval has passed (S1010).

When determining based on the time that the end time of the first time interval has not yet passed (No at S1010), the processing section 125c continues the processing of the image in the selection range within in the captured image for the first time based on the captured image data. The time acquisition section 125d subsequently acquires the time again (S1008).

Alternatively, when determining based on the time that the end time of the first time interval has passed (Yes at S1010), the processing section 125c ends the processing of the image in the selection range during the first time interval (S1012). The processing section 125c subsequently determines whether or not the time is included in the second time interval (S1014). When the processing section 125c determines that the time is not included in the second time interval (No at S1014), the time acquisition section 125d acquires the time (S1016).

In contrast, when determining that the time is included in the second time interval (Yes at S1014), the processing section 125c starts processing of an image in the selection range within the captured image during the second time interval based on the captured image data (S1018). The time acquisition section 125d subsequently acquires the time (S1020). The processing section 125c then determines based on the time whether or not the end time of the second time interval has passed (S1022).

When determining based on the time that the end time of the second time interval has not yet passed (No at S1022), the processing section 125c continues the processing of the image in the selection range within in the captured image during the second time interval based on the captured image data. The time acquisition section 125d subsequently acquires the time again (S1020). When determining based on the time that the end time of the second time interval has passed (Yes at S1022), the processing section 125c ends the processing of the image in the selection range during the second time interval (S1024). The operation as described above enables the monitoring system 100 to switch between the selection ranges.

A process of switching between selection ranges in the monitoring system 100 according to the present embodiment will hereinafter be described with reference to FIGS. 1 and 10. For example, it is assumed that a time interval from 11 a.m. to 12 a.m. is set as a first time interval and a time interval from 1 p.m. to 3 p.m. is set as a second time interval.

When the time acquired through the time acquisition section 125d is 10:00 a.m. (S1002), the processing section 125c determines that the time is not included in the first time interval (No at S1004). The time acquisition section 125d subsequently acquires the time again.

When the time acquired through the time acquisition section 125d is 11:00 a.m. (S1002), the processing section 125c determines that the time is included in the first time interval (Yes at S1004). The processing section 125c starts processing of an image in the selection range during the first time interval (S1006). The time acquisition section 125d subsequently acquires the time (S1008). When the time acquired through the time acquisition section 125d is 11:30 a.m., the processing section 125c determines based on the time that the end time of the first time interval has not yet passed (No at S1010). In this case, the processing section 125c continues the processing of the image in the selection range within the captured image during the first time interval.

Subsequently, when the time acquired through the time acquisition section 125d is 12:00 a.m., the processing section 125c determines based on the time that the end time of the first time interval passes (Yes at S1010). The processing section 125c ends the processing of the image in the selection range during the first time interval (S1012). When the processing section 125c subsequently determines that the time is not included in the second time interval (No at S1014), the time acquisition section 125d acquires the time (S1016).

When the time acquired through the time acquisition section 125d is 1:00 p.m., the processing section 125c determines that the time is included in the second time interval (Yes at S1014). The processing section 125c starts processing of an image in the selection range within the captured image during the second time interval (S1018). The time acquisition section 125d subsequently acquires the time (S1020).

When the time acquired through the time acquisition section 125d is 2:00 p.m., the processing section 125c determines based on the time that the end time of the second time interval has not yet passed (No at S1022). The processing section 125c continues the processing of the image in the selection range within the captured image during the second time interval. The time acquisition section 125d subsequently acquires the time (S1020).

When the time acquired through the time acquisition section 125d is 3:00 p.m., the processing section 125c determines based on the time that the end time of the second time interval passes (Yes at S1022). The processing section 125c then ends the processing of the image in the selection range during the second time interval (S1024). The operation as described above enables switching between the selection ranges within the captured image at time intervals.

The monitoring system 100 according to the present embodiment is preferably used for monitoring a place where the position of a person changes from time to time. For example, the monitoring system 100 is suitably used for monitoring a platform of a station.

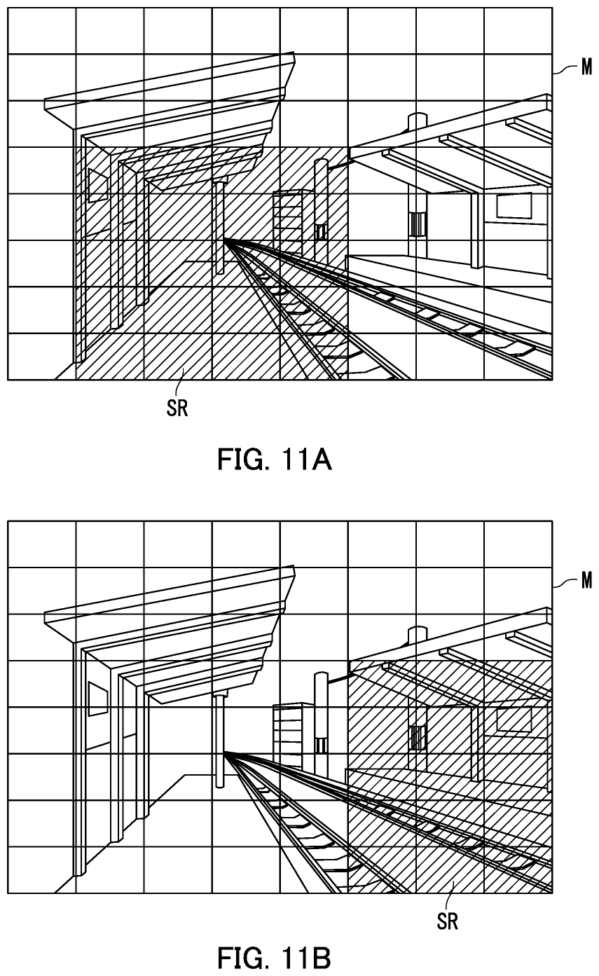

Switching between selection ranges SR at time intervals in the monitoring system 100 according to the present embodiment will hereinafter be described with reference to FIGS. 1, 11A, and 11B. FIG. 11A is a schematic illustration of a captured image M, in which a selection range SR is set, during a time interval. FIG. 11B is a schematic illustration of the captured image M, in which a different selection range SR is set, during a different time interval. Each of FIGS. 11A and 11B illustrates a captured image M obtained by capturing side platforms.

As illustrated in FIG. 11A, during a time interval, a selection range SR is set on the left side in the captured image M. A side platform on the left side in the captured image M is a platform where trains (up trains) arrive from a suburb and leave towards a city center. For example, in the morning, the left side part in the captured image M is set as a selection range SR. The setting section 125b sets the left side part of the selection range candidates CS as the selection range SR.

On the other hand, the right side part in the captured image M is set as a different selection range SR during a different time interval as illustrated in FIG. 11B. A side platform on the right side in the captured image M is a platform where trains (down trains) arrive from the city center and leave towards the suburb. For example, in the afternoon, the right side part in the captured image M is set as the different selection range SR. The setting section 125b sets the right side part of the selection range candidates CS as the different selection range SR. The configuration described above enables one imaging sensor 111 to perform efficient monitoring because of being switchable between the selection ranges SR in the captured image M at the time intervals to which the number of persons varies according.

Note that although the device controller 125 includes the allocation section 125a, the setting section 125b, the processing section 125c, the time acquisition section 125d, and the count section 125e as described above with reference to FIGS. 1 to 11B, the present invention is not limited to this. The camera controller 114 may perform respective functions similar to the respective functions of the allocation section 125a, the setting section 125b, the processing section 125c, the time acquisition section 125d, and the count section 125e of the device controller 125.

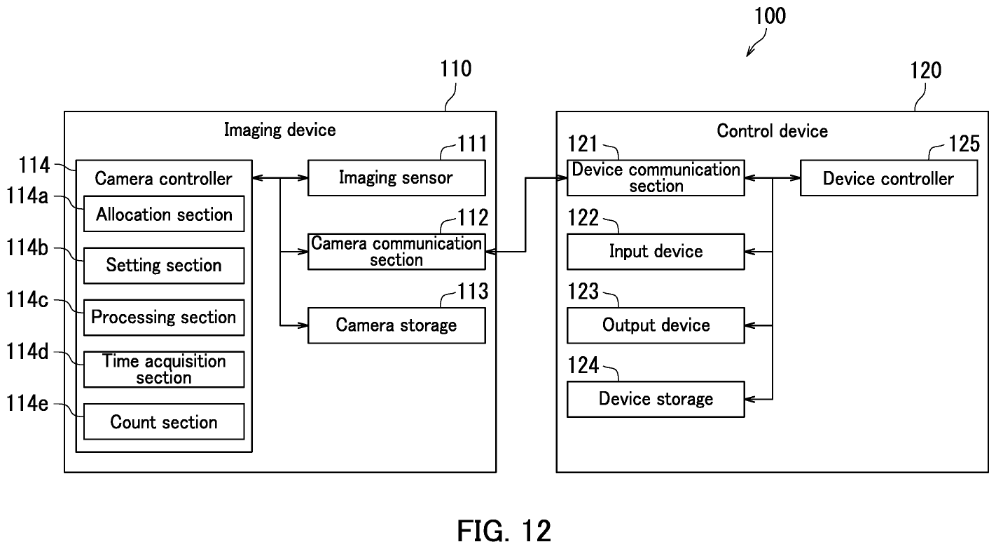

A monitoring system 100 according to the present embodiment will be described with reference to FIG. 12. FIG. 12 is a block diagram of the monitoring system 100. The monitoring system 100 illustrated in FIG. 12 has a configuration similar to that of the monitoring system 100 illustrated in FIG. 10 except that the camera controller 114 includes an allocation section 114a, a setting section 114b, a processing section 114c, a time acquisition section 114d, and a count section 114e in place of the allocation section 125a, the setting section 125b, the processing section 125c, the time acquisition section 125d, and the count section 125e. For this reason, in the following description, redundant description will be omitted to avoid redundancy.

The camera controller 114 in the monitoring system 100 according to the present embodiment includes the allocation section 114a, the setting section 114b, the processing section 114c, the time acquisition section 114d, and the count section 114e. The allocation section 114a, the setting section 114b, the processing section 114c, the time acquisition section 114d, and the count section 114e of the camera controller 114 perform respective functions similar to those of the allocation section 125a, the setting section 125b, the processing section 125c, the time acquisition section 125d, and the count section 125e of the device controller 125 described above with reference to FIG. 1. It is however preferable that the operator perform allocation of selection range candidates, and setting of a time interval and a selection range through the input device 122 of the control device 120.

For example, the setting section 114b sets part of the selection range candidates as a mask range. In this case, the mask range entered through the input device 122 is transmitted to the imaging device 110 through the device communication section 121. The setting section 114b performs mask processing before captured image data generated by the imaging sensor 111 is transmitted from the camera communication section 112 to the device communication section 121 of the control device 120. As describe above, the allocation section 114a, the setting section 114b, the processing section 114c, the time acquisition section 114d, and the count section 114e of the camera controller 114 may perform the respective functions similar to those of the allocation section 125a, the setting section 125b, the processing section 125c, the time acquisition section 125d, and the count section 125e of the device controller 125 described above with reference to FIG. 1.

The embodiment of the present invention has been described above with reference to the drawings (FIGS. 1 to 12). However, the present invention is not limited to the above embodiment and may be implemented in various manners within a scope not departing from the gist of the present invention. Furthermore, the configurations illustrated in the above embodiment are examples and are not particularly limited. The configurations may be variously altered within a scope not substantially departing from the effects of the present invention.

For example, although selection range candidates are allocated to the entire captured image as described above with reference to FIGS. 3 to 8B, 11A, and 11B, the present invention is not limited to this. The selection range candidates may be allocated to part of the captured image. In this case, the selection range candidates are preferably allocated to part of the captured image. Here, the part corresponds to a subject to be noticed.

### INDUSTRIAL APPLICABILITY

The present invention is useful in the field of monitoring systems.

1. A monitoring system, comprising:
an imaging sensor configured to capture an image in a capture area to generate captured image data representing a captured image;
an allocation section configured to allocate selection range candidates to the captured image; and
a setting section configured to set at least part of the selection range candidates as a selection range, the at least part including one or more selection range candidates, wherein
according to a time interval, the setting section performs switching of the at least part of the selection range candidates that is set as the selection range, and
the setting section resets, based on the time interval, one or more selection range candidates adjacent to the at least part as a further selection range.

2. The monitoring system according to claim 1, wherein
the allocation section allocates, to the captured image, the selection range candidates arranged in a matrix of rows and columns.

3. The monitoring system according to claim 1, further comprising
a processing section configured to perform processing of an image in the selection range within the captured image based on the captured image data.

4. The monitoring system according to claim 3, wherein
the processing section detects the image in the selection range within the captured image based on the captured image data.

5. The monitoring system according to claim 3, wherein
the processing section masks the selection range within the captured image based on the captured image data.

6. The monitoring system according to claim 1, further comprising
a count section configured to count a number of times a change of an image in the selection range is detected, wherein
the setting section resets different at least part of the selection range candidates that is to be set as a different selection range based on a different time interval and the counted number of times.

7. (canceled)

8. The monitoring system according to claim 1, wherein
the setting section sets the at least part of the selection range candidates as the selection range, the at least part being neighboring selection range candidates, and
the setting section cancels, based on the time interval, setting of the selection range of one or more selection range candidates of the neighboring selection range candidates.

9. The monitoring system according to claim 1, wherein
the selection range candidates include a cancellation prohibition candidate that is a selection range candidate prohibited from being canceled from setting as the selection range.
the setting section sets the cancellation prohibition candidate as the selection range.

10. The monitoring system according to claim 1, further comprising:
an imaging device including the imaging sensor; and
a control device including the allocation section and the setting section, the control device being configured to control the imaging device.

11. The monitoring system according to claim 1, further comprising:
an imaging device including the image sensor, the allocation section and the setting section; and
a control device configured to control the imaging device.

12. A monitoring system, comprising:
an imaging sensor configured to capture an image in a capture area to generate captured image data representing the captured image;
an allocation section configured to allocate selection range candidates to the captured image; and
a setting section configured to set at least part of the selection range candidates as a selection range, the at least part including one or more selection range candidates, wherein according to a time interval, the setting section performs switching of the at least part of the selection range candidates that is set as the selection range,
the setting section sets the at least part of the selection range candidates as the selection range, the at least part being neighboring selection range candidates, and
the setting section cancels, based on the time interval, setting of the selection range of one or more selection range candidates of the neighboring selection range candidates.

13. The monitoring system according to claim 12, wherein
the allocation section allocates, to the captured image, the selection range candidates arranged in a matrix of rows and columns.

14. The monitoring system according to claim 12, further comprising
a processing section configured to perform processing of an image in the selection range within the captured image based on the captured image data.

15. The monitoring system according to claim 14, wherein
the processing section detects the image in the selection range within the captured image based on the captured image data.

16. The monitoring system according to claim 14, wherein
the processing section masks the selection range within the captured image based on the captured image data.

17. The monitoring system according to claim 12, further comprising
a count section configured to count a number of times a change of an image in the selection range is detected, wherein
the setting section resets different at least part of the selection range candidates that is to be set as a different selection range based on a different time interval and the counted number of times.

18. The monitoring system according to claim 12, wherein
the selection range candidates include a cancellation prohibition candidate that is a selection range candidate prohibited from being canceled from setting as the selection range.
the setting section sets the cancellation prohibition candidate as the selection range.

19. The monitoring system according to claim 12, further comprising:
an imaging device including the imaging sensor; and
a control device including the allocation section and the setting section, the control device being configured to control the imaging device.

20. The monitoring system according to claim 12, further comprising:
an imaging device including the image sensor, the allocation section and the setting section; and
a control device configured to control the imaging device.
